(19) United States
(12) Patent Application Publication
(10) Pub. No.: US 2023/0147774 A1
(43) Pub. Date: May 11, 2023

(54) PROCESS FOR CONTINUOUSLY FORMING A RAW EGG PRODUCT

(71) Applicant: TYSON FOODS, INC., Springdale, AR (US)

(72) Inventors: Zachary T. Young, Springdale, AR (US); Robert L. Hill, Jr., Enid, OK (US)

(21) Appl. No.: 17/985,011

(22) Filed: Nov. 10, 2022

Related U.S. Application Data
(60) Provisional application No. 63/277,839, filed on Nov. 10, 2021.

(51) Int. Cl. A23B 5/04; A23B 5/055; A23L 15/00

(52) U.S. Cl. CPC A23B 5/043; A23B 5/055; A23L 15/20; A23L 15/30

(57) ABSTRACT

In accordance with this disclosure, a process for producing egg products is provided. The process comprises: (a) providing a raw egg mixture, wherein the raw egg mixture includes a plurality of egg components; (b) mixing the raw egg mixture; (c) lowering the temperature of the raw egg mixture to a level sufficient to cause the raw egg mixture to have a semi-solid state; and (d) after step (c), while maintaining the temperature of the raw egg mixture at a level sufficient to cause the raw egg mixture to have a semi-solid state, continuously forming the semi-solid raw egg mixture into a plurality of shaped and portioned semi-solid raw egg products.

### CROSS-REFERENCE TO RELATED APPLICATION

This application claims the benefit of prior-filed U.S. provisional application No. 63/277,839 (filed on Nov. 10, 2021), which is incorporated by reference herein.

### BACKGROUND

Eggs are very versatile food items that not only provide a good source of protein and other essential nutrients when consumed but also serve as useful ingredients in many other types of food products. The most commonly consumed and used egg is the chicken egg.

For example, eggs and egg products are used by schools, restaurants and other food service operators in a variety of ways. They can be used to prepare center of plate egg entries (e.g., scrambled eggs, eggs benedict, omelets), or can be used as functional ingredients (e.g., thickening agents, leavening agents) in connection with the preparation of other food products.

In some applications, fully cooked egg products are desired. Such products can be frozen in advance for subsequent use when needed. Fully cooking the egg products increases the shelf life of the products and allows them to be distributed in bulk and stored.

In other applications, raw egg products are needed. For example, depending on the type of cooking process and type of product involved, raw eggs often function differently than fully cooked eggs. For example, raw egg products can be used to create other types of products that are cooked from scratch.

Unfortunately, it can be difficult to continuously produce and distribute egg products in bulk on a large-scale commercial basis, particularly on a continuous-flow food production line. For example, commercial forming and portioning equipment and other types of equipment typically used on continuous-flow food production lines are not designed and/or set up to process egg products. Egg products are typically in in liquid or slurry form and not capable of withstanding the relatively harsh processing conditions associated with a continuous-flow food production process. It can particularly difficult, both from practical and logistic standpoints, to produce and distribute raw egg products on a large-scale basis.

There is a need for a more streamlined and efficient process for producing egg products, particularly raw egg products, on a large-scale commercial basis.

### SUMMARY

In accordance with this disclosure, a process for producing egg products is provided. The process comprises: (a) providing a raw egg mixture, wherein the raw egg mixture includes a plurality of egg components; (b) mixing the raw egg mixture; (c) lowering the temperature of the raw egg mixture to a level sufficient to cause the raw egg mixture to have a semi-solid state; and (d) after step (c), while maintaining the temperature of the raw egg mixture at a level sufficient to cause the raw egg mixture to have a semi-solid state, continuously forming the semi-solid raw egg mixture into a plurality of shaped and portioned semi-solid raw egg products.

### BRIEF DESCRIPTION OF THE DRAWINGS

The drawings included with this application illustrate certain aspects of specific embodiments of the process disclosed herein. However, the embodiments disclosed herein, as shown by the drawings, should not be viewed as the exclusive embodiments. The subject matter disclosed herein is capable of considerable modifications, alterations, combinations, and equivalents in form and function, as will occur to those skilled in the art with the benefit of this disclosure. For example, the specific views in the drawings are not representative of the exact size of the items shown. The drawings are not necessarily to scale and the proportions of certain parts may have been exaggerated to better illustrate details and features of the present disclosure.

FIG. 1 is a process flow chart illustrating embodiments of the process disclosed herein.

FIG. 2 is a schematic perspective view of the outside of a Formax® ULTRA26® forming machine (a “Formax® machine”) that can be used in connection with the forming step of the process disclosed herein.

FIGS. 3-5 are enlarged schematic sectional views of the Formax® machine illustrated by FIG. 2 showing movement of the raw egg mixture through various sections thereof.

FIG. 6 is an exploded schematic view illustrating how a flow directing insert is configured with respect to other components within the Formax® machine illustrated by FIG. 2.

FIG. 7 is an enlarged schematic view further illustrating how the flow directing insert is configured with respect to other components of the Formax® machine illustrated by FIG. 2.

FIG. 8 is a cross-sectional view taken along line 8-8 of FIG. 7.

### DETAILED DESCRIPTION

The present disclosure may be understood more readily by reference to this description as well as to the specific embodiments described herein. Numerous specific details are set forth in order to provide a thorough understanding of the disclosed subject matter and the various embodiments described herein. However, it will be understood by those of ordinary skill in the art that the subject matter and embodiments described herein can be practiced without these specific details. Also, this description is not to be considered as limiting the scope of the subject matter described herein or any claims appended hereto.

As used herein and in the appended claims, the following terms and phrases have the corresponding definitions set forth below.

A component that “comprises” or “includes” one or more specified compounds means that the component includes the specified compound(s) alone, or includes the specified compound(s) together with one or more additional compounds.

A component that “consists of” one or more specified compounds means that the component includes only the specified compound(s).

A component that “consists essentially of” one or more specified compounds means that the component consists of the specified compound(s) alone, or consists of the specified compound(s) together with one or more additional compounds that do not materially affect the basic properties of the component.

Whenever a range is disclosed herein, the range includes independently and separately every member of the range extending between any two numbers enumerated within the range. Furthermore, the lowest and highest numbers of any range shall be understood to be included within the range set forth.

In accordance with this disclosure, a process for producing an egg product is provided. The process comprises:

(a) providing a raw egg mixture, wherein the raw egg mixture includes a plurality of egg components;

(b) mixing the raw egg mixture;

(c) lowering the temperature of the raw egg mixture to a level sufficient to cause the raw egg mixture to have a semi-solid state; and

(d) after step (c), while maintaining the temperature of the raw egg mixture at a level sufficient to cause the raw egg mixture to have a semi-solid state, continuously forming the semi-solid raw egg mixture into a plurality of shaped and portioned raw egg products.

As used herein and in the appended claims, “continuously forming the raw egg mixture into a plurality of shaped and portioned semi-solid raw egg products” as in step (d) means that the raw egg mixture is continuously formed into a plurality of shaped and portioned semi-solid raw egg products on a continuous-flow production line without interruption for a period of time, as opposed to a batch process. Continuously forming the raw egg mixture into a plurality of shaped and portioned raw egg products allows the egg products to be produced by the process in commercial quantities.

For example, the process as a whole can be carried out on a continuous basis. As used herein and in the appended claims, stating that “the process as a whole can be carried out on a continuous basis” means that that the process as a whole can be carried out without interruption for a period of time, even if a single, continuous-flow production line is not used for the whole process, or one or more steps of the process are carried out as batch process steps. For example, in the process disclosed herein, even though the forming step (step (d) of the process as set forth above) and optionally the freezing and packaging steps described below are carried out on a continuous basis (on a continuous-flow production line), steps (a), (b) and/or (c) of the process (as set forth above) can be carried out as batch process steps. For example, even though they are batch process steps, steps (a), (b) and/or (c) can be carried out at a pace and in a manner sufficient to generate at least enough output to keep up with the forming step (step (d)) so that there is no disruption in the total process flow.

As used herein and in the appended claims, providing a raw egg mixture means providing the raw egg mixture or providing the components thereof, either together or separately. For example, in addition to a plurality of egg components, the raw egg mixture can include added water (water in addition to water naturally present in the egg components) and one or more additional components as set forth below.

As used herein and in the appended claims, an egg component means a whole egg or a portion of a whole egg. Examples of portions of whole eggs include egg whites and egg yolks. A “raw egg mixture” means that the egg components of the egg mixture have not been denatured; i.e., the egg components have not been cooked or otherwise processed sufficiently to cause the chains of amino acids in the egg components to be changed from their original state.

For example, the raw egg mixture can be in liquid form. As used herein and in the appended claims, stating that the raw egg mixture is in liquid form means that the raw egg mixture is either a liquid or a mixture of solids suspended in a liquid. For example, the raw egg mixture is a liquid. For example, the raw egg mixture is a mixture of solids suspended in a liquid.

Raw egg mixtures in blended liquid form are available on a commercial basis. For example, a typical commercially-available raw egg mixture in blended liquid form has been pasteurized and modified as needed with egg whites and/or egg yolks to meet standard specifications in terms of protein content and other nutritional values. Such commercially-available raw egg mixtures can be used as, or as a starting point, for the raw egg mixture used in the process disclosed herein.

Any type of egg components can be used to form the raw egg mixture. For example, the egg components forming the raw egg mixture can be poultry egg components. For example, the components forming the raw egg mixture can be chicken egg components.

For example, the raw egg mixture provided for use in the process can be a pasteurized raw egg mixture. As used herein and in the append the claims, a “pasteurized raw egg mixture” means a raw egg mixture wherein the raw egg mixture as a whole or the egg components thereof are heated to destroy bacteria or viruses without denaturing the egg components; i.e., without causing the chains of amino acids in the egg components to be changed from their original state. Liquid egg blends are generally pasteurized to ensure food safety.

For example, the raw egg mixture provided for use in the process can be a homogenized raw egg mixture. As used herein and in the append the claims, a “homogenized raw egg mixture” means a raw egg mixture wherein the raw egg mixture as a whole or the egg or egg components thereof are subject to an emulsification step to emulsify the fat therein without denaturing the eggs or egg components, that is, without causing the chains of amino acids in the egg components to be changed from their original state.

For example, the raw egg mixture can include an additional component selected from the group consisting of one or more food items, one or more functional ingredients, one or more flavoring ingredients, and combinations thereof. In one embodiment, the additional component(s) are included as part of the raw egg mixture that is provided for use in the process. In another embodiment, the additional component(s) are combined with the raw egg mixture as part of the process. For example, the additional component(s) can be added to the raw egg mixture and mixed together therewith in the mixing step, step (b).

For example, the food item(s) can be selected from the group of beef, chicken and pork, cheese, vegetables, hash browns, a baking mix, bread, egg white powder, egg yolk powder, and combinations thereof. An example of pork is sausage. For example, the baking mix can be a baking mix including flour, starch, shortening, yeast, baking powder, and combinations thereof. For example, the food item(s) can be selected from the group of, breakfast sausage, bacon, ground beef, cheddar cheese, mozzarella cheese, provolone cheese, parmesan cheese, peppers, onions, mushrooms, spinach, tomatoes, potatoes, and combinations thereof. For example, the functional ingredient(s) can be selected from the group of salt, food starch, binders, antimicrobial agents, chelating agents, buffers, gums, thickening agents, agents used to modify the water holding capacity of the mixture, leavening agents, and combinations thereof. An example of a gum that can be used is xanthan. Examples of leavening agents that can be used include yeast and baking powder. For example, the functional ingredient(s) can be selected from the group of baking powder, sodium acid pyrophosphate (SAPP), cream of tartar, xanthan gum, carrageenan, locust bean gum, guar gum, tapioca, rice, corn, or potato starch (native or modified), rice, corn, wheat, tapioca flours (whole, refined, or enriched), oat, potato or citrus fibers, vinegar, citric acid, lactic acid, malic acid, acetic acid, salt, phosphates, preservatives, antioxidants (including butylated hdroxyanisole (BHA) and butylated hydroxytoluene (BHT)), rosemary, and combinations thereof.

For example, the flavoring ingredient(s) can be selected from the group of seasonings, sugar, edible oils, flavor enhancers, marinades, and combinations thereof. Examples of seasonings that can be used include salt, pepper, chili powder, hot sauce, tarragon, dill and basil. An example of a flavor enhancer is a smoke flavoring such as smoked paprika, smoked olive oil, smoked cheese, and liquid smoke. Examples of marinades that can be used include ranch salad dressing and hot and spicy marinades. For example, the flavoring ingredient(s) can be selected from the group of spices, paprika, fennel, coriander, pepper, chili flake, herbs, rosemary, parsley, thyme, liquid flavorings, basil, honey, balsamic vinegar, agave, worcestershire sauce, soy sauce. flavor enhancers, salt, sugar, monosodium glutamate (MSG), sodium inosinate and guanylate (I&G), natural flavors, artificial flavors, smoke char, grill flavors, and combinations thereof.

The amount of the additional component that can be included in the raw egg mixture will vary greatly depending on type of raw egg product being produced and other factors known to those skilled in the art. For example, the additional component can be present in the raw egg mixture in an amount in the range of about 0.01% by weight to about 95% by weight, based on the total weight of the raw egg mixture. For example, the additional component can be present in the raw egg mixture in an amount in the range of about 5% by weight to about 80% by weight, based on the total weight of the raw egg mixture. For example, the additional component is present in the raw egg mixture in an amount in the range of about 40% by weight to about 60% by weight, based on the total weight of the raw egg mixture.

As used herein and in the appended claims, “mixing the raw egg mixture” as in step (b) of the process as set forth above means mixing, blending or otherwise combining the components (including any additional components) of the raw egg mixture together. The raw egg mixture can be mixed in a mixer. For example, the mixer can be a blender. The mixing time will vary depending on whether the raw egg mixture includes one or more additional components, the desired viscosity of the raw egg blend, and the type of mixing equipment utilized. For example, the raw egg mixture can be mixed in accordance with step (b) by blending the raw egg mixture in a paddle blender. For example, the raw egg mixture can be blended in a paddle blender for about 5 to about 30 minutes. For example, the raw egg mixture can be blended in a paddle blender for about 5 to about 15 minutes. For example, the raw egg mixture can be blended in a paddle blender for about 1 to about 2 minutes.

For example, the viscosity of the raw egg mixture mixed in accordance with step (b) of the process with no additional components added thereto, before the temperature of the raw egg mixture is lowered in accordance with step (c) of the process, is typically in the range of from about 10 centipoises to about 500 centipoises, more. For example, the viscosity of the raw egg mixture mixed in accordance with step (b) with one or more additional components added thereto, before the temperature of the raw egg mixture is lowered in accordance with step (c), is in the range of from about 10 centipoises to about 2000 centipoises. The exact viscosity of the raw egg mixture at this point will vary depending on, for example, the temperature, the amount of liquid in the mixture, and the nature of the egg components and any additional components.

As used herein and in the appended claims, stating that the raw egg mixture has a “semi-solid state” as in steps (c) and (d) of the process set forth above means that the raw egg mixture has qualities of both a solid and a liquid. Similarly, “semi-solid raw egg products” as in step (d) means egg products that have qualities of both a solid and a liquid. Eggs are made up of a complex mixture of water, fat, protein and carbohydrates. As a result, when cooled to the required temperature, certain components of the raw egg mixture will solidify while others stay in liquid form.

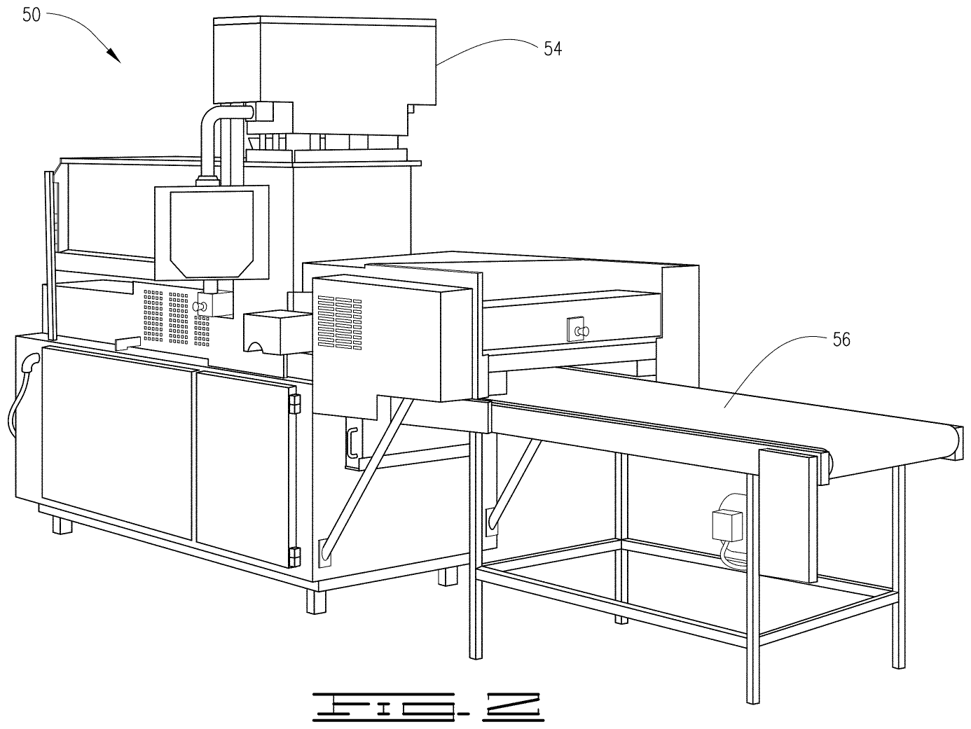

For example, the semi-solid raw egg mixture and semi-solid raw egg products have a thick paste-like texture that is solid enough to cause the mixture and products to hold their own shape, but liquid enough to be manipulated and formed into different shapes. For example, when the raw egg mixture is in a semi-solid state, a commercially available forming machine such as the machine illustrated by FIGS. 2-8 can be used to form the mixture into a plurality of shaped and portioned semi-solid raw egg products in accordance with step (d). The semi-solid raw egg mixture and semi-solid raw egg products can handle the rigors of commercial forming and other processing equipment. They are malleable enough to be manipulated by the mechanical forces of the equipment but solid enough to retain their shapes unassisted by a container, vessel, or other separate mechanism. For example, the texture and viscosity of the semi-solid raw egg mixture and semi-solid raw egg products resembles the texture and viscosity of potter's clay or plumber's putty.

For example, the temperature of the raw egg mixture can be lowered to a level sufficient to cause the raw egg mixture to have a semi-sold state in accordance with step (c) by injecting a supercooled liquid into the raw egg mixture. For example, the supercooled liquid can be selected from the group of liquid carbon dioxide (CO₂) and liquid nitrogen (N₂). For example, the supercooled liquid can be liquid carbon dioxide (CO₂). For example, the supercooled liquid can be liquid nitrogen (N₂). The supercooled liquid can be injected into the raw egg mixture using a commercial chilling system (for example, including pressurized supercooled liquid tanks and lines and connectors that connect to commercial food processing equipment).

The temperature of the raw egg mixture can be lowered to a level sufficient to cause the raw egg mixture to have a semi-sold state in accordance with step (c) by other means as well. For example, a cooling jacket through which a coolant is circulated an be placed around the paddle blender or other mixer used to mix the raw egg mixture in accordance with step (b). A coolant can then be circulated through the jacket to lower the temperature of the raw egg mixture in the mixture to the required level.

In one embodiment, the process further comprises the step of: contemporaneously with or after injecting a gas into the raw egg mixture to lower the temperature thereof in accordance with step (c), applying a vacuum to the raw egg mixture to remove residual gas from the raw egg mixture. For example, the vacuum can be applied at a level in the range of from about 1 to about 30 inches mercury (hg). The vacuum can be applied for about 2 minutes. Removal of the residual gas can help prevent popping when the raw egg mixture hits the cold surfaces of the forming equipment and other issues in the forming step, step (d). For example, the vacuum step also helps reduce the volume of the raw egg mixture.

For example, the temperature to which the raw egg mixture is lowered in accordance with step (c) and maintained in accordance with step (d) is in the range of about 16° F. to about 30° F. For example, the temperature to which the raw egg mixture is lowered in accordance with step (c) and maintained in accordance with step (d) is in the range of about 20° F. to about 28° F. For example, the temperature to which the raw egg mixture is lowered in accordance with step (c) and maintained in accordance with step (d) is in the range of about 22° F. to about 26° F. For example, the temperature to which the raw egg mixture is lowered in accordance with step (c) and maintained in accordance with step (d) is in the range of about 22° F. to about 24° F. The exact temperature within the above ranges to which the raw egg mixture is lowered in accordance with step (c) and maintained in accordance with step (d) will depend on, for example, the nature of any functional ingredients in the raw egg mixture, the size of the portion, the shape being formed, and the type of forming equipment to be used. For example, salt and other functional ingredients can depress, shift or otherwise modify the freezing point of the raw egg mixture.

For example, the temperature of the raw egg mixture can be lowered in accordance with step (c) while the raw egg mixture is being mixed in accordance with step (b). For example, a supercooled liquid can be injected into the raw egg mixture while the raw egg mixture is in the paddle blender using a commercial chilling system as discussed above. Most commercial paddle blenders and other commercial food processing equipment have inlets and/or other components installed thereon that allow for the injection of supercooled liquids and other components.

As used herein, “continuously forming the raw egg mixture into a plurality of shaped and portioned semi-solid raw egg products” means forming the raw egg mixture into a plurality of semi-solid raw egg products that have a desired shape and desired weight. A variety of specific shapes can be formed, including cylindrical shapes (like a puck or patty), longitudinal shapes (like a burrito) and nugget shapes (like a chicken nugget). The desired weight can be within a certain range, for example, in the range of from about 1 gram to about 500 grams.

For example, the shaped and portioned raw egg products formed in accordance with step (d) can have flat cylindrical shapes in the form of a puck. In this case, for example, each semi-solid raw egg product can have a diameter in the range of about 1.0 cm to about 10 cm, a thickness in the range of about 4 cm to about 6 cm, and a weight in the range of about 10 grams to about 100 grams. As another example, the shaped and portioned raw egg products formed in accordance with step (d) can have flat cylindrical shapes in the form of a patty. In this case, each semi-solid product can have a diameter in the range of about 0.5 cm to about 2 cm, a thickness in the range of about 6 cm to about 12 cm, and a weight in the range of about 20 grams to about 80 grams.

The above dimensions are the dimensions of the raw egg products immediately following the shaping and portioning step, step (d) of the process as set forth above. The dimensions can change if and when the products are further processed. For example, regardless of the dimensions, each portioned and shaped and portioned raw egg product can have approximately the same dimensions.

The raw egg mixture can be continuously formed into a plurality of shaped and portioned semi-solid raw egg products using one or more pieces of commercial food processing portioning and/or shaping equipment. For example, as discussed further below, a Formax® machine, a Revo portioning machine (also known as a “RevoPortioner), and other types of equipment can be utilized to carry out the forming step (step (d)) of the process.

As used herein and in the appended claims, “maintaining the temperature of the raw egg mixture at a level sufficient to cause the raw egg mixture to have a semi-solid state” in step (d) of the process means carrying out the process under conditions sufficient to ensure that the temperature of the raw egg mixture remains at a level sufficient to cause the raw egg mixture to have a semi-solid state from the time the temperature is lowered to a level sufficient to cause the raw egg mixture to have a semi-solid state in accordance with step (c) to at least the time the shaped and portioned semi-solid raw egg products are formed in accordance with the forming step, step (d). Various steps can be taken to make sure that the process is carried out under conditions sufficient to ensure that the temperature of the raw egg mixture remains at a level sufficient to cause the raw egg mixture to have a semi-solid state during the specified time period.

For example, the temperature in the area of the plant in which the process is carried out can be maintained at a relatively low level, for example, about 40° F. to about 50° F. The time to transfer the raw egg mixture from the equipment in which it is cooled in accordance with step (c) (for example, the paddle blender or other mixer in which the raw egg mixture is mixed in accordance with step (b) and cooled in accordance with step (c)) to the equipment used to continuously form the raw egg mixture into a plurality of shaped and portioned semi-solid raw egg products in step (d) can be minimized. For example, more than one paddle blender or other mixer can be used.

Importantly, the forming step itself, step (d), can be carried out at a rate sufficient to ensure that the temperature remains at a sufficient level throughout the step. A sufficient forming rate will vary depending upon a number of factors including the type of forming and portioning equipment utilized, the number of forming and portioning machines utilized, the amount of product being produced and other factors. For example, when a single Formax® forming machine is utilized, a sufficient rate can generally be in the range of about 1,000 pounds to about 10,000 pounds per hour, and is more typically in the range of about 4,000 pounds to about 8,000 pounds per hour. If necessary, more than one forming machine can be used.

Also, contact with the internal surfaces of the forming equipment with which the semi-solid raw egg mixture comes into contact, including surfaces that surround dead space within the equipment, can be minimized. Due do friction and other factors, contact of the raw egg mixture with internal surfaces of forming equipment tends to heat up the raw egg mixture. By taking steps to minimize the contact area between the internal surfaces of the forming equipment and the semi-sold raw egg mixture, the degree of friction and corresponding rise in the temperature of the semi-solid raw egg mixture can be minimized. One way in which contact of the raw egg mixture with the internal surfaces of a Formax® forming and portioning machine can be minimized is illustrated below.

In the event that the required temperature at which the forming step, step (d), is carried out cannot be maintained for some reason, the raw egg mixture in the forming equipment can be transferred back to the blender or other equipment in which the temperature of the raw egg mixture is lowered in accordance with step (c) and re-run through the process from that point forward.

After the forming step (step (d)), the semi-solid raw egg product can be frozen and packaged. The freezing and packaging steps can be carried out continuously, for example, on the same continuous-flow production line on which the semi-solid raw egg mixture is formed into a plurality of shaped and portioned semi-solid raw egg products. The frozen and packaged egg products can then be stored in a freezer and/or shipped through normal channels of trade. In the event that the required temperature or form of the raw egg products cannot be maintained for some reason prior to or in connection with the freezing and/or packaging step, the raw egg mixture can be transferred back to the blender or other equipment in which the temperature of the raw egg mixture is lowered in accordance with step (c) and re-run through the process from that point forward.

In one embodiment (the “raw egg embodiment”), the egg products continuously formed by the process disclosed herein are raw egg products. As used herein and in the appended claims, a “raw egg product” means an egg product in which the egg components in the product have not been denatured; i.e., the egg components have not been cooked or otherwise processed sufficiently to cause the chains of amino acids in the egg components to be changed from their original state.

For example, in the raw egg embodiment, the process can further comprise: (e) after step (d), while maintaining the temperature of the shaped and portioned raw egg products at a level sufficient to cause the shaped and portioned raw egg products to have a semi-solid state, freezing the shaped and portioned raw egg products formed in accordance with step (d). As used herein and in the appended claims, “maintaining the temperature of the shaped and portioned raw egg products at a level sufficient to cause the shaped and portioned raw egg products to have a semi-solid state” in step (e) of the process means carrying out the process under conditions sufficient to assure that the temperature of the shaped and portioned raw egg products remains at a level sufficient to cause the shaped and portioned raw egg products to have a semi-solid state from the time the shaped and portioned raw egg products are formed in accordance with step (d) until the shaped and portioned raw egg products are frozen in accordance with the freezing step, step (e). The freezing step (step (e)) can be continuously carried out. Freezing the products fully solidifies the products.

For example, in the raw egg embodiment, the shaped and portioned raw egg products can be individually frozen in a flash freezer (such as a linear carbon dioxide or nitrogen tunnel freezer). For example, if a linear carbon dioxide tunnel freezer is used, the average freeze time is 2-10 minutes depending on the nature of the product and temperature involved. If a linear nitrogen tunnel freezer is used, the average freeze time is 1-10 minutes depending on the nature of the product and temperature involved.

For example, in the raw egg embodiment, the shaped and portioned raw egg products can also be individually frozen in a slower, more traditional freezer such as a spiral freezer. For example, the average freeze time in a spiral freezer is 6-30 minutes depending on the nature of the product and temperature involved.

For example, in the raw egg embodiment, the process can further comprise: (f) after step (e), packaging the frozen shaped and portioned raw egg products formed in accordance with step (d). For example, in the raw egg embodiment, the frozen shaped and portioned raw egg products can be packaged by placing the products into bags, and placing the bags in cases or boxes, on the continuous-flow production line. If desired, insulated packaging can be used to help keep the raw egg products in a frozen state.

In an alternative embodiment (the “cooked egg embodiment”), the egg products continuously produced by the process set forth above are cooked egg products. As used herein and in the appended claims, a cooked egg product means an egg product in which the egg components in the product have been denatured; i.e., the egg components have been cooked or otherwise processed sufficiently to cause the chains of amino acids in the egg components to be changed from their original state. For example, by denaturing the egg components (also described as denaturing the protein in the egg components) sets the external shape of the products so that an end user will be able to heat the products gradually without melting them before the proteins have a chance to set.

In the cooked egg embodiment, the process further comprises: after the shaped and portioned raw egg products are formed in accordance with step (d), cooking the shaped and portioned raw egg products. For example, the shaped and portioned raw egg products formed in accordance with step (d) can be par cooked or fully cooked. As used herein and in the appended claims, “par cooking” the raw egg products means partially cooking the products without fully cooking the products. “Fully cooking” the raw egg products means cooking the products sufficiently to make them ready to eat without further cooking in accordance with applicable government standards.

For example, in the cooked egg embodiment, the shaped and portioned raw egg products formed in accordance with step (d) can be cooked (par cooked or fully cooked) via direct contact with a high heat surface ranging from 200° F. to 600° F. As another example, the shaped and portioned raw egg products formed in accordance with step (d) can be cooked (par cooked or fully cooked) using a commercial microwave oven. As yet another example, the shaped and portioned raw egg products formed in accordance with step (d) can be cooked (par cooked or fully cooked) by submersion into a water bath ranging from 150° F. to 212° F.

For example, in the cooked egg embodiment, the shaped and portioned raw egg products formed in accordance with step (d) can be par cooked at a temperature in the range of from about 340° F. to about 400° F. for a time period in the range of from about 30 seconds to about 110 seconds. For example, in the cooked egg embodiment, the shaped and portioned raw egg products can be par cooked by partially frying the products, for example, in vegetable oil.

For example, in the cooked egg embodiment, the shaped and portioned raw egg products formed in accordance with step (d) can be fully cooked by subjecting the products to a full lethality heat process step (e.g., cooking step) in accordance with government standards. For example, the shaped and portioned raw egg products can be fully cooked in an oven. For example, the shaped and portioned raw egg products can be fully cooked in an oven for in the range of from about 4 minutes to about 10 minutes at a temperature in the range of from about 350° F. to about 425° F. The cooking step can be carried out by running the products through a spiral or linear oven.

In in the cooked egg embodiment, the process can further comprise: after cooking the shaped and portioned raw egg products, freezing the cooked shaped and portioned raw egg products. The cooked shaped and portioned raw egg products can be frozen in the manners set forth above in connection with in the raw egg embodiment.

In in the cooked egg embodiment, the process can also further comprise: after freezing the shaped and portioned raw egg products, packaging the frozen shaped and portioned raw egg products. The frozen shaped and portioned raw egg products can be packaged in the manner set forth above in connection with the raw egg embodiment.

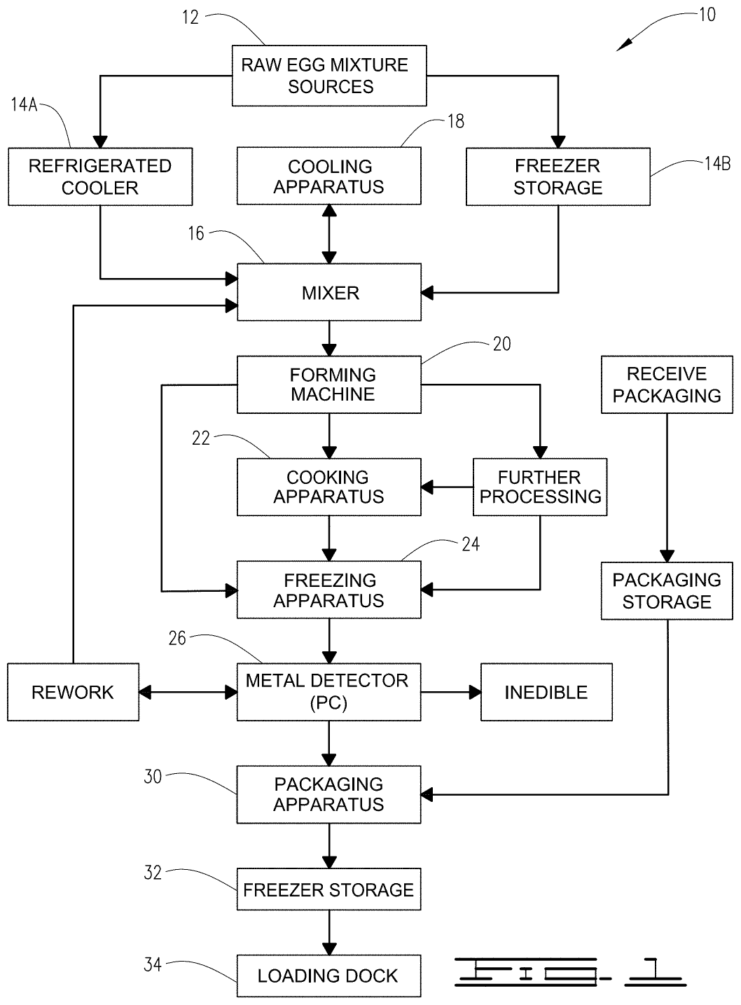

Referring now to FIG. 1, a flow diagram illustrating how the process disclosed herein (including both the raw egg embodiment and the cooked egg embodiment) can be carried out, generally designated by the reference numeral 10, is illustrated.

As shown by FIG. 1, a raw egg mixture or the components thereof are provided from a source 12 and transferred to a mixer 16. Although a single source 12 of the raw egg mixture is illustrated in FIG. 1, the components of the raw egg mixture can come from multiple sources 12. For example, the raw egg mixture 12 can be in liquid form and include a plurality of egg components and an additional component as described above. If desired, the raw egg mixture or one or more components thereof can be stored in a refrigerated cooler 14A or freezer 14B and held prior to being transferred to the mixer 16 as needed.

The raw egg mixture is then mixed in the mixer 16 (for example, in a paddle blender 16). In the embodiment illustrated, while the raw egg mixture is being mixed in the mixer 16 in accordance with step (b) of the process, the temperature of the raw egg mixture is lowered to a level sufficient to cause the raw egg mixture to have a semi-solid state in accordance with step (c) of the process. The temperature can be lowered to the desired level using cooling apparatus 18. For example, the temperature of the raw egg mixture can be lowered to a level in the range of about 16° F. to about 30° F. by injecting nitrogen gas (N₂) into the raw egg mixture while the raw egg mixture is being mixed in the mixer 16.

Once the temperature of the raw egg mixture is lowered to the desired level, the semi-solid raw egg mixture is transferred to a forming machine 20 (for example, a Formax® forming machine) and continuously formed into a plurality of shaped and portioned semi-solid raw egg products. The raw egg mixture can be provided, mixed and cooled at a pace that is at least as fast as or keeps up with the forming step so that there is no disruption in the total process flow.

In the raw egg embodiment, as discussed above, the shaped and portioned semi-solid raw egg products are then conveyed or otherwise transferred to a freezer apparatus 24 and frozen. If desired, for example, prior to being conveyed or otherwise transferred to a freezer apparatus 24 and frozen, the shaped and portioned semi-solid raw egg products can be further processed (for example, run through a breading applicator).

In the cooked egg embodiment, prior to being transferred to the freezer apparatus 24, the shaped and portioned semi-solid raw egg products are first conveyed or otherwise transferred to a cooking apparatus 22 (for example, frying apparatus or an oven) and cooked. Once cooked to the desired level in the cooking apparatus 22, the cooked raw egg products are conveyed and transferred to the freezer apparatus 24. If desired, for example, prior to being conveyed or otherwise transferred to the cooking apparatus 22 and cooked, the shaped and portioned semi-solid raw egg products can be further processed (for example, run through a breading applicator).

Once frozen by the freezer apparatus 24, the frozen shaped and portioned raw egg products or frozen shaped and portioned cooked egg products are run through a metal detector 26 to make sure there are no metal particles in the products. The products are also visually inspected to see if there is any reason they should be reworked or discarded. If metal particles are detected, the products are discarded. If the products are to be reworked, they are conveyed or otherwise transferred back to the mixer 16 where they are cooled by the cooling apparatus 18 and run again through the process from that point forward.

The frozen shaped and portioned raw egg products or frozen shaped and portioned cooked egg products are then conveyed or otherwise transferred to a packaging apparatus 30 and packaged as described above. The packaged products can be stored in a freezer 32 and then shipped from a loading dock 34 to a desired destination.

FIGS. 2-8 illustrate a Formax® ULTRA26® forming machine (the “Formax® machine”), which is one example of a type of forming machine that can be used to form the semi-solid raw egg mixture into a plurality of shaped and portioned semi-solid egg products in accordance with step (d) of the process disclosed herein. As discussed below, a flow directing insert has been added to the machine in order to minimize contact of the raw egg mixture with internal surfaces or dead space within the machine.

FIG. 2 is a perspective view of the outside of the Formax® machine, which is generally designated by the reference number 50. The mixed and chilled semi-solid raw egg mixture is added to the machine 50 through a top hopper 54. The formed and shaped semi-solid raw egg products are discharged by the machine 50 onto a moving conveyor belt 56.

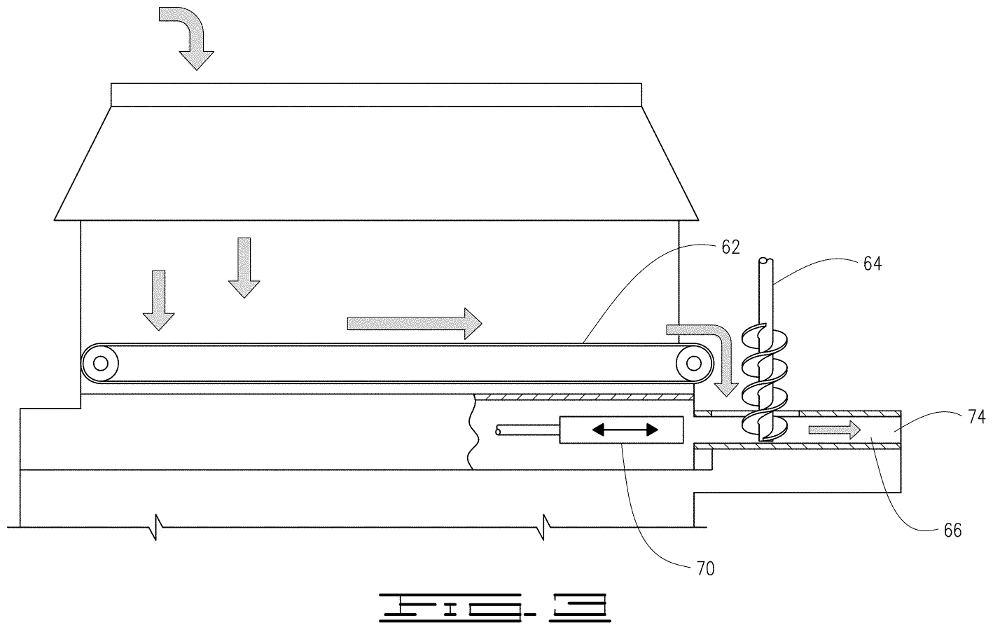

As shown by FIG. 3, the semi-solid raw egg mixture moves through the hopper 54 to an internal conveyor belt 62 where it is moved to one or more vertical feed screws 64. The semi-solid raw egg mixture is then pushed by the vertical feed screw(s) 64 down into one or more plunger boxes 66 that are positioned underneath the feed screw(s). One or more hydraulic reciprocating presses or plungers 70 then push the raw egg mixture in the plunger box(es) 66 through slots 74 in the back of the boxes and into a fill tube 76.

As shown by FIGS. 4 and 5, the raw egg mixture ends up in an open cavity 78 under the fill tube 76. A specially designed flow directing insert 80 is placed in the open cavity 78 under the fill tube 76. FIGS. 4 and 5 show the fill tube 76 and flow directing insert 80 from the open cavity looking up. As shown, the semi-solid raw egg mixture flows through the flow directing insert 80 and directly up through a fill plate 84 and attached mold plate 86.

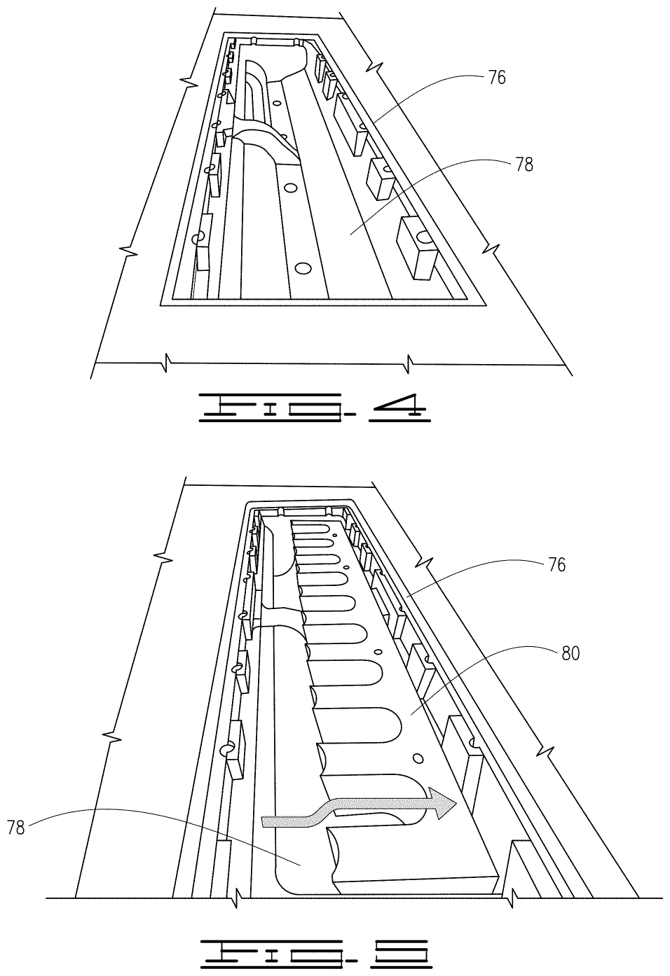

FIG. 6 is an exploded view illustrating the open cavity 78, flow directing insert 80, fill plate 84 and mold plate 86 in detail. The open cavity 78, flow directing insert 80, fill plate 84 and mold plate 86 all line up to direct the flow of the semi-solid raw egg mixture as it is forced upwardly through openings 88 in the fill plate into openings (molded cut-outs) 90 in the mold plate 84 to form the semi-solid raw egg mixture into a plurality of shaped and portioned semi-solid raw egg products.

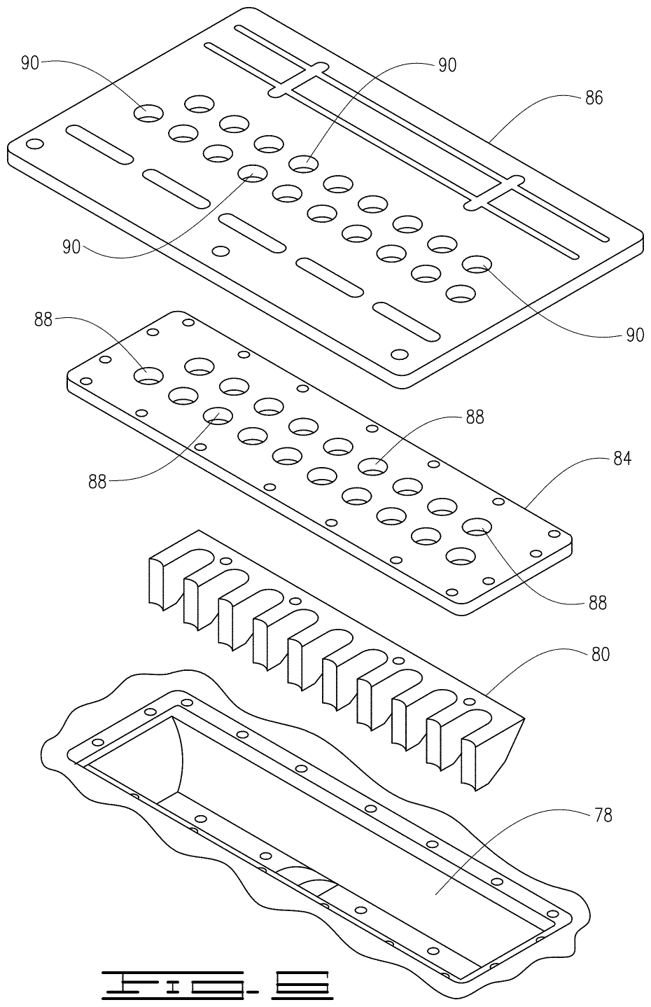

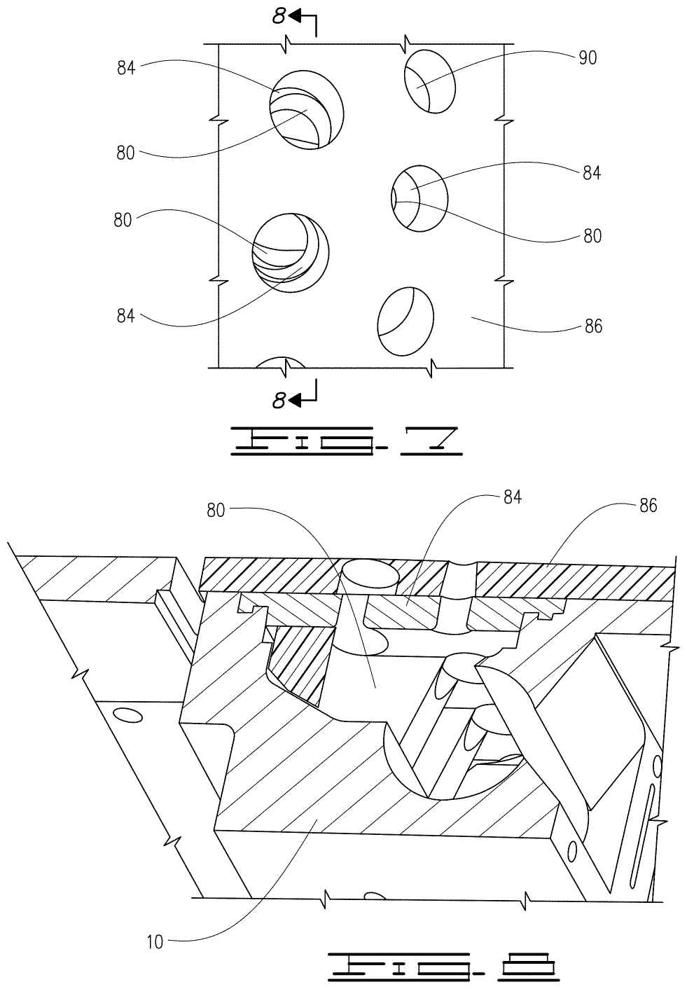

FIGS. 7 and 8 illustrate how the flow directing insert 80, fill plate 84 and mold plate 86 are configured and interact with each other and how the parts are positioned within the Formax® machine. FIG. 7 is a sectional view looking down at the mold plate 86 on top of the fill plate 84 with the flow directing insert 80 positioned therein. FIG. 8 is a perspective cross-sectional view taken along the line 8-8 in FIG. 7 and further illustrates the mold plate 86, fill plate 84, and flow directing insert 80 as positioned in the Formax® machine 10.

In operation, the flow directing insert 80, fill plate 84 and mold plate 86 oscillate back and forth between a pressurized filling area formed by the open cavity 78 and a positioned over the moving conveyor belt 56. The pressurized filling area is full of the raw egg mixture. The mold plate 86 is oriented such that one end of it has the series of openings (cut-outs) and the other end is a solid surface. As the mold plate 86 is drawn into the open cavity 78, the openings in the mold plate end are exposed to the open cavity, and pressure from the hydraulic plunger(s) pushes product into the openings. Thus, the openings (molded cut-outs) of the mold plate 86 are filled each time the flow directing insert 80, fill plate 84 and mold plate 86 oscillate into the pressurized filling area. When the flow directing insert 80, fill plate 84 and mold plate 86 oscillates back over the moving conveyor belt 56, a punch roughly the size and shape of the openings (cut-outs) in the mold plate punches the semi-solid raw egg products in the openings onto the moving conveyor belt 56 which moves it just far enough away so that the next time the plate oscillates in to be filled and out to be punched again, the product is out of the way of additional product being formed.

The flow directing insert 80 directs the flow of the raw egg mixture to minimize contact of the mixture with warm internal surfaces of the machine and help reduce the corresponding amount of friction and back pressure that the semi-solid raw egg mixture is exposed to in the Formax® machine. For example, the flow directing insert 80 effectively “funnels” the raw egg mixture more directly into the openings in the mold plate 86. The overall assembly of the flow directing insert 80, fill plate 84 and mold plate 86 reduces friction between the raw egg mixture and the oscillating assembly. By funneling the raw egg mixture in the open fill cavity 78 directly to the openings in the mold plate 86, the chance that the raw egg mixture will get trapped underneath the fill cavity and in other dead space within the machine is reduced which further aids in maintaining a consistent temperature of the mixture. Thus, the temperature of the raw egg mixture is maintained at a level sufficient to cause the mixture to have a semi-solid state throughout the forming process.

Another example of commercial forming and portioning equipment that can be used to form a plurality of shaped and portioned semi-solid raw egg products in step (d) is a Revo commercial portioner. For example, such a portioner, often referred to as a “RevoPortioner,” utilizes a hollow drum spinning on a horizontal axis. A series of three-dimensional shapes are molded/cut into this drum to achieve very dynamic shapes. Pressed up against one side of this drum is a pressurized feeding tube that is spread across the entire face of the drum. Product is pressed against the drum thereby filling the molds as the drum spins on a horizontal axis. As the filled molds are spun around facing the ground a burst of air from inside the drum is forced through micro channels etched into the molds to force the product in each mold to release and land on a moving conveyor belt. The conveyor belt moves at a speed matched by the drum so each new set of pieces dropped narrowly misses the last. Again, the process can vary in speed, but in full production happens very rapidly.

Additional types of commercial forming and portioning equipment that can be used to form a plurality of shaped and portioned raw egg products in step (d) can be used as well. Examples include commercial meatball formers and sausage stuffers.

If desired, the frozen raw egg products can be further processed and/or used to make various additional types of food products. For example, in a separate or supplemental process, the frozen raw egg products can be dropped into a tortilla and the combination egg/tortilla product can be fully cooked and frozen.

Thus, in accordance with the process disclosed herein, egg products, including raw egg products and cooked egg products, can be mass produced on a commercial basis using commercial food processing equipment and a continuous-flow production line. The process can result in substantial cost savings compared to traditional methods of forming raw egg products. For example, individual trays and/or expensive molds are not required to form the product. The raw egg product can be packaged, stored, distributed and sold in bulk in frozen form.

The process disclosed herein provides a more flexible and more efficient way of forming raw egg products. It allows for eggs to be formed and frozen for later use in a raw state rather than a fully cooked state which is a potential benefit to an end consumer or operator. For example, a food service operator can cook from something frozen that appears and performs as though it was cooked fresh. If needed, the raw egg products can be par cooked or fully cooked prior to being frozen. It allows the creation of off shoot products that use eggs as a base, but include other ingredient in the blend, such as egg bites, seasoned egg patties, souffles, souffle bites, frittatas, omelets, etc.

The following examples illustrate specific embodiments consistent with the present disclosure but do not limit the scope of the disclosure or the appended claims.

### Example 1

The following formulations for the raw egg mixture were prepared and used to prepare a plurality of shaped and portioned semi-solid raw egg products in a pilot plant in accordance with the process disclosed herein. The particular formulations noted do not encompass all possible formulations. In carrying out the tests, a production line was set up, and the steps of the process disclosed herein were carried out on a continuous basis (as defined herein).

Patty Blend

| Components | Amount (% by weight) |
|---|---|
| Potatoes | 14-16% |
| Cheese | 20-23% |
| Raw Egg Mixture | 61-64% |
| Seasoning | 0.5-2% |
| Total | 100.00 |

1. Weigh Out Components
2. Add all components to paddle blender and blend until combined. Mix the components in the paddle blender for two minutes prior to chilling the mixture.
3. While blending in the paddle blender, chill mix with CO2 until it is formable (24-26 F.).
4. Once desired temperature is reached, while continuing to blend in the paddle blender, pull vacuum (20 in hg) for 2 minutes
5. Load into the Formax ® and form using plate 11128-6 and at a rate in the range of from about 200 pounds per hour to about 250 pounds per hour.
6. Freeze in Frigo Spiral Freezer for about 6 to about 30 minutes.
7. Pack out

Patty Blend

| Components | Amount (% by weight) |
|---|---|
| Potatoes | 14-16% |
| Cheese | 20-23% |
| Raw Egg Mixture | 61-64% |
| Seasoning | 0.5-2% |
| Total | 100.00 |

1. Weigh Out Components
2. Add all components to paddle blender and blend until combined. Mix the components in the paddle blender for two minutes prior to chilling the mixture.
3. While blending in the paddle blender, chill mix with CO2 until it is formable (24-26 F.)
4. Once desired temperature is reached, while continuing to blend in the paddle blender, pull vacuum (20 in hg) for 2 minutes
5. Load into the Formax ® and form using plate 11128-6 and at a rate in the range of from about 200 pounds per hour to about 250 pounds per hour.
6. Freeze in Frigo Spiral Freezer for about 6 to about 30 minutes.
7. Pack out

Sausage Blend

| Components | Amount (% by weight) |
|---|---|
| Potatoes | 7-10% |
| Cheese | 20-23% |
| Sausage | 9-13% |
| Raw Egg Mixture | 41-45% |
| Milk | 17-21% |
| Starch | 0.1-2% |
| Xanthan | 0.01-1% |
| Salt | 0.1-1% |
| Total | 100.00 |

1. Weigh Out Components
2. Add all components to paddle blender and blend until combined. Mix the components in the paddle blender for two minutes prior to chilling the mixture.
3. While blending in the paddle blender, chill mix with CO2 until it is formable (24-26 F.)
4. Once desired temperature is reached, while continuing to blend in the paddle blender, pull vacuum (20 in hg) for 2 minutes
5. Load into the Formax ® and form using plate 13033-6 and at a rate in the range of from about 200 pounds per hour to about 250 pounds per hour.
6. Freeze in Frigo Spiral Freezer for about 6 to about 30 minutes.
7. Pack out

Sausage Blend

| Components | Amount (% by weight) |
|---|---|
| Potatoes | 7-10% |
| Cheese | 20-23% |
| Sausage | 9-13% |
| Raw Egg Mixture | 41-45% |
| Milk | 17-21% |
| Starch | 0.1-2% |
| Xanthan | 0.01-1% |
| Salt | 0.1-1% |
| Total | 100.00 |

1. Weigh Out Components
2. Add all components to paddle blender and blend until combined. Mix the components in the paddle blender for two minutes prior to chilling the mixture.
3. While blending in the paddle blender, chill mix with CO2 until it is formable (24-26 F.)
4. Once desired temperature is reached, while continuing to blend in the paddle blender, pull vacuum (20 in hg) for 2 minutes
5. Load into the Formax ® and form using plate 13033-6 and at a rate in the range of from about 200 pounds per hour to about 250 pounds per hour.
6. Freeze in Frigo Spiral Freezer for about 6 to about 30 minutes.
7. Pack out

Veggie Blend

| Components | Amount (% by weight) |
|---|---|
| Starch Blend | 12-15% |
| Cheese | 7-10% |
| Raw Egg Mixture | 48-52% |
| Spinach | 1-5% |
| Mushroom | 5-10% |
| Milk | 15-20% |
| Total | 100.00 |

1. Weigh Out Components
2. Add all components to paddle blender and blend until combined. Mix the components in the paddle blender for two minutes prior to chilling the mixture.
3. While blending in the paddle blender, chill mix with CO2 until it is formable (24-26 F.)
4. Once desired temperature is reached, while continuing to blend in the paddle blender, pull vacuum (20 in hg) for 2 minutes
5. Load into the Formax ® and form using plate 13033-6 and at a rate in the range of from about 200 pounds per hour to about 250 pounds per hour.
6. Freeze in Frigo Spiral Freezer for about 6 to about 30 minutes.
7. Pack out

Veggie Blend

| Components | Amount (% by weight) |
|---|---|
| Starch Blend | 12-15% |
| Cheese | 7-10% |
| Raw Egg Mixture | 48-52% |
| Spinach | 1-5% |
| Mushroom | 5-10% |
| Milk | 15-20% |
| Total | 100.00 |

1. Weigh Out Components
2. Add all components to paddle blender and blend until combined. Mix the components in the paddle blender for two minutes prior to chilling the mixture.
3. While blending in the paddle blender, chill mix with CO2 until it is formable (24-26 F.)
4. Once desired temperature is reached, while continuing to blend in the paddle blender, pull vacuum (20 in hg) for 2 minutes
5. Load into the Formax ® and form using plate 13033-6 and at a rate in the range of from about 200 pounds per hour to about 250 pounds per hour.
6. Freeze in Frigo Spiral Freezer for about 6 to about 30 minutes.
7. Pack out

Bacon Blend

| Components | Amount (% by weight) |
|---|---|
| Starch Blend | 13-17% |
| Cheese | 9-13% |
| Tomato | 1-5% |
| Onion | 0.1-2% |
| Bacon | 9-13% |
| Raw Egg Mixture | 58-62% |
| Total | 100.0 |

1. Weigh Out Components
2. Add all components to paddle blender and blend until combined. Mix the components in the paddle blender for two minutes prior to chilling the mixture.
3. While blending in the paddle blender, chill mix with CO2 until it is formable (24-26 F.)
4. Once desired temperature is reached, while continuing to blend in the paddle blender, pull vacuum (20 in hg) for 2 minutes
5. Load into the Formax ® and form using new plate Top of plate diameter - 36 mm, Bottom of Plate diameter - 42 mm, Plate thickness - 25.4 mm or 1 inch, Drop weight roughly 1 oz, and form at a rate in the range of from about 200 pounds per hour to about 250 pounds per hour.
6. Freeze in Frigo Spiral Freezer for about 6 to about 30 minutes.
7. Pack out in 5 lb bags

Patty Blend

| Components | Amount (% by weight) |
|---|---|
| Potatoes | 13-17% |
| Cheese | 20-24% |
| Raw Egg Mixture | 60-65% |
| Total | 100.00 |

1. Weigh Out Components
2. Add all components to paddle blender and blend until combined. Mix the components in the paddle blender for two minutes prior to chilling the mixture.
3. While blending in the paddle blender, chill mix with CO2 until it is formable (24-26 F.)
4. Once desired temperature is reached, while continuing to blend in the paddle blender, pull vacuum (20 in hg) for 2 minutes
5. Load into the Formax ® and form using plate 11128-6 and at a rate in the range of from about 200 pounds per hour to about 250 pounds per hour.
6. Freeze in Frigo Spiral Freezer for about 6 to about 30 minutes.
7. Pack out

Breakfast Blend (No Milk)

| Components | Amount (% by weight) |
|---|---|
| Potatoes | 11-15% |
| Cheese | 15-20% |
| Sausage | 11-15% |
| Raw Egg Mixture | 52-55% |
| Total | 100.00 |

1. Weigh Out Components
2. Add all components to paddle blender and blend until combined. Mix the components in the paddle blender for two minutes prior to chilling the mixture.
3. While blending in the paddle blender, chill mix with CO2 until it is formable 24-26 F.
4. Once desired temperature is reached, while continuing to blend in the paddle blender, pull vacuum (20 in hg) for 2 minutes
5. Load into the Formax ® and form using new plate Top of plate diameter - 36 mm, Bottom of Plate diameter - 42 mm, Plate thickness - 25.4 mm or 1 inch, Drop weight roughly 1 oz, and form at a rate in the range of from about 200 pounds per hour to about 250 pounds per hour.
6. Freeze in Frigo Spiral Freezer for about 6 to about 30 minutes.
7. Pack out

Breakfast Blend (Milk)

| Components | Amount (% by weight) |
|---|---|
| Potatoes | 10-15% |
| Cheese | 13-18% |
| Sausage | 10-15% |
| Raw Egg Mixture | 40-45% |
| Milk | 15-20% |
| Total | 100.00 |

1. Weigh Out Components
2. Add all components to paddle blender and blend until combined. Mix the components in the paddle blender for two minutes prior to chilling the mixture.
3. While blending in the paddle blender, chill mix with CO2 until it is formable (24-26 F.)
4. Once desired temperature is reached, while continuing to blend in the paddle blender, pull vacuum (20 in hg) for 2 minutes
5. Load into the Formax ® and form using new plate Top of plate diameter - 36 mm, Bottom of Plate diameter - 42 mm, Plate thickness - 25.4 mm or 1 inch, Drop weight roughly 1 oz, and form at a rate in the range of from about 200 pounds per hour to about 250 pounds per hour.
6. Freeze in Frigo Spiral Freezer for about 6 to about 30 minutes.
7. Pack out

The tests of the above formulations were successful indicating that the raw egg products can be produced in a full-scale plant on a continuous basis.

### Example 2

In addition to the above, the following formulations for the raw egg mixture were prepared and used to prepare a plurality of shaped and portioned semi-solid raw egg products in a pilot plant in accordance with the process disclosed herein. The types of products prepared do not encompass all possible formulations. In carrying out the tests, a production line was set up, and the steps of the process disclosed herein were carried out on a continuous basis (as defined herein).

| Product | Product Type | Description | Size and Shape |
|---|---|---|---|
| Chorizo | Formed IQF | Liquid egg, | 1.1 oz frozen puck |
| Egg Bite | Raw Cylinder | potato, cheese, | using test plate |
| | | milk, functional | 13037-6 |
| | | components, | |
| | | and sausage | |
| | | formed and | |
| | | frozen | |
| Seasoned | Formed IQF | Liquid egg, | 2.1 oz Frozen patty |
| Egg Patty | Raw Puck | potato cheese, | using test plate |
| | | and sausage | 11128-6 |
| | | formed and | |
| | | frozen | |
| Veggie | Formed IQF | Liquid egg, | 1.1 oz frozen puck |
| Souffle Bite | Raw Cylinder | flavored/seasoned | using test plate |
| | | biscuit mix, | 13037-6 |
| | | cheese, veggies, | |
| | | formed and | |
| | | frozen | |

The tests of the above formulations were successful indicating that the raw egg products can be produced in a full-scale plant on a continuous basis.

### Example 3

A plurality of shaped and portioned semi-solid raw egg products was continuously produced, frozen and packaged on a full-scale production line in a plant in accordance with the process disclosed herein. The raw egg mixture was mixed in a paddle blender, and the temperature of the raw egg mixture was lowered in the paddle blender to about 22° F. to about 24° F. The forming machine used to produce the raw egg products was a Formax® ULTRA26® forming machine as illustrated in FIGS. 2-8 of this disclosure. The machine included the flow directing insert 80, fill plate 84 and mold plate 86 shown by the drawings. The semi-solid raw egg products were continuously formed by the forming machine at a rate of about 6000 pounds per hour. The formed semi-solid raw egg products were then frozen and packaged.

The formulation of the raw egg mixture used to form the raw egg products included a functional blend, cheese, sausage, raw egg components and water.

The process was successfully carried out to produce raw egg products that all required specifications.

Therefore, the process disclosed herein is well adapted to attain the ends and advantages mentioned, as well as those that are inherent therein. The particular example disclosed above is illustrative only, as the process disclosed herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative example disclosed above may be altered or modified, and all such variations are considered within the scope and spirit of the present process. While the present process and system and the individual steps and components thereof may be described in terms of “comprising,” “containing,” “having,” or “including” various steps or components, the process and system can also, in some examples, “consist essentially of” or “consist of” the various steps and components. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A process for producing egg products, comprising:
(a) providing a raw egg mixture, wherein said raw egg mixture includes a plurality of egg components;
(b) mixing said raw egg mixture;
(c) lowering the temperature of said raw egg mixture to a level sufficient to cause said raw egg mixture to have a semi-solid state; and
(d) after step (c), while maintaining the temperature of the raw egg mixture at a level sufficient to cause the raw egg mixture to have a semi-solid state, continuously forming said semi-solid raw egg mixture into a plurality of shaped and portioned semi-solid raw egg products.

2. The process of claim 1, wherein said process as a whole is carried out on a continuous basis.

3. The process of claim 1, wherein said raw egg mixture is in liquid form.

4. The process of claim 1, wherein the egg components forming said raw egg mixture are chicken egg components.

5. The process of claim 1, wherein said raw egg mixture further includes an additional component selected from the group consisting of one or more food items, one or more functional ingredients, one or more flavoring ingredients, and combinations thereof.

6. The process of claim 5, wherein said food item(s) is selected from the group of beef, chicken and pork, cheese, vegetables, hash browns, a baking mix, bread, and combinations thereof.

7. The process of claim 5, wherein said functional ingredient(s) is selected from the group of salt, food starch, binders, antimicrobial agents, chelating agents, buffers, gums, thickening agents, agents used to modify the water holding capacity of the mixture, leavening agents, and combinations thereof.

8. The process of claim 5, wherein said flavoring ingredient(s) is selected from the group of seasonings, sugar, edible oils, flavor enhancers, marinades, and combinations thereof.

9. The process of claim 1, wherein said raw egg mixture is mixed in accordance with step (b) by blending the raw egg mixture in a paddle blender.

10. The process of claim 1, wherein the temperature of said raw egg mixture is lowered to a level sufficient to cause the raw egg mixture to have a semi-sold state in accordance with step (c) by injecting a gas into the raw egg mixture.

11. The process of claim 10, wherein said gas is selected from the group of carbon dioxide, nitrogen, and combinations thereof.

12. The process of claim 10, further comprising the step of contemporaneously with or after injecting a gas into said raw egg mixture to lower the temperature thereof in accordance with step (c), applying a vacuum to said raw egg mixture to remove residual gas from said raw egg mixture.

13. The process of claim 1, wherein the temperature to which the raw egg mixture is lowered in accordance with step (c) and maintained in accordance with step (d) is in the range of about 16° F. to about 30° F.

14. The process of claim 13, wherein the temperature to which the raw egg mixture is lowered in accordance with step (c) and maintained in accordance with step (d) is in the range of about 22° F. to about 26° F.

15. The process of claim 1, wherein the temperature of said raw egg mixture is lowered in accordance with step (c) while said raw egg mixture is being mixed in accordance with step (b).

16. The process of claim 1, further comprising: (e) after step (d), while maintaining the temperature of the shaped and portioned raw egg products at a level sufficient to cause the shaped and portioned raw egg products to have a semi-solid state, freezing the shaped and portioned raw egg products formed in accordance with step (d).

17. The process of claim 16, further comprising: (f) after step (e), packaging the frozen shaped and portioned raw egg products formed in accordance with step (d).

18. The process of claim 1, further comprising: after the shaped and portioned raw egg products are formed in accordance with step (d), cooking the shaped and portioned raw egg products.

19. A process for continuously producing raw egg products, comprising:
(a) providing a raw egg mixture; wherein said raw egg mixture includes a plurality of egg components;
(b) mixing said raw egg mixture;
(c) lowering the temperature of said raw egg mixture to a level sufficient to cause the raw egg mixture to have a semi-solid state;
(d) after step (c), while maintaining said raw egg mixture at a temperature sufficient to cause the raw egg mixture to have a semi-solid state, continuously forming said semi-solid raw egg mixture into a plurality of shaped and portioned semi-solid raw egg products, wherein the temperature to which the raw egg mixture is lowered in accordance with step (c) and maintained in accordance with step (d) is in the range of about 16° F. to about 30° F.;
(e) after step (d), while maintaining the temperature of the shaped and portioned raw egg products at a level sufficient to cause the shaped and portioned raw egg products to have a semi-solid state, freezing the shaped and portioned raw egg products formed in accordance with step (d); and
(f) after step (e), packaging the frozen shaped and portioned raw egg products formed in accordance with step (d).

20. The process of claim 18, wherein said raw egg mixture further includes an additional component selected from the group consisting of one or more food items, one or more functional ingredients, one or more flavoring ingredients, and combinations thereof.

21. A process for continuously producing raw egg products, comprising:
(a) providing a raw egg mixture; wherein said raw egg mixture includes a plurality of egg components and an additional component selected from the group consisting of one or more food items, one or more functional ingredients, one or more flavoring ingredients, and combinations thereof;
(b) mixing said raw egg mixture;
(c) lowering the temperature of said raw egg mixture to a level sufficient to cause the raw egg mixture to have a semi-solid state;
(d) after step (c), while maintaining said raw egg mixture at a temperature sufficient to cause the raw egg mixture to have a semi-solid state, continuously forming said semi-solid raw egg mixture into a plurality of shaped and portioned semi-solid raw egg products, wherein the temperature to which the raw egg mixture is lowered in accordance with step (c) and maintained in accordance with step (d) is in the range of about 20° F. to about 28° F., and wherein said process as a whole is carried out on a continuous basis;
(e) after step (d), while maintaining the temperature of the shaped and portioned raw egg products at a level sufficient to cause the shaped and portioned raw egg products to have a semi-solid state, continuously freezing the shaped and portioned raw egg products formed in accordance with step (d); and
(f) after step (e), while maintaining the temperature of the shaped and portioned raw egg products at a level sufficient to cause the shaped and portioned raw egg products to have a semi-solid state, continuously packaging the shaped and portioned raw egg products formed in accordance with step (d).
